(19) United States
(12) Patent Application Publication
(10) Pub. No.: US 2018/0357636 A1
(43) Pub. Date: Dec. 13, 2018

(54) POINT OF SALE TERMINAL FOR ACCEPTING PAYMENT THROUGH MULTIPLE DIGITAL PAYMENT TECHNIQUES

(71) Applicant: Protinus Infotech Private Limited, Gurugram (IN)

(72) Inventors: Narender KUMAR, Gurugram (IN); Rahul GOCHHWAL, New Delhi (IN); Vivek LOHCHEB, Gurgaon (IN)

(21) Appl. No.: 15/691,523

(22) Filed: Aug. 30, 2017

(30) Foreign Application Priority Data
Jun. 10, 2017 (IN) 201711020359

(51) Int. Cl. G06Q 20/36; G06Q 20/20; G06Q 20/40

(52) U.S. Cl. CPC G06Q 20/367; G06Q 20/204; G06F 3/04842; G06Q 20/209; G06Q 20/40145

(57) ABSTRACT

The present disclosure provides a point of sale terminal. The point of sale terminal includes a graphical user interface screen. The graphical user interface screen allows the merchant and the customer to interact with the point of sale terminal in real time. Moreover, the point of sale terminal includes a digital payment card swiping mechanism installed on the point of sale terminal. Further, the point of sale terminal includes a chip reader mechanism installed on the point of sale terminal. Furthermore, the point of sale terminal includes a biometric scanner for real time biometric verification of the customer. Also, the point of sale terminal includes software installed inside a hardware layer of the point of sale terminal. In addition, the point of sale terminal includes a printing mechanism. The printing mechanism allows auto-printing of one or more payment receipts in real time on completion of the digital payment transaction.

### TECHNICAL FIELD

The present disclosure relates to the field of wireless point of sale transactions. In particular, the present disclosure relates to a point of sale terminal for accepting digital payment through multiple digital payment techniques.

### BACKGROUND

With the rise in demand for cashless based transactions, there has been a swift emergence of a number of digital payment solutions in the market. These digital payment solutions enable the customers to perform online and offline payment through their mobile devices. These digital payment solutions allow payment through credit card, debit card, loyalty points and digital wallets. In addition, there have been various new digital payment technologies introduced in the market. These new digital payment technologies include payment through QR code processing, payment through a unique identification number and the like. Nowadays, the customers are well versed with how to perform an online or an offline transaction using these digital payment solutions in real time. The customers may make the payment to an online merchant through a mobile application or a website. Alternatively, the customers may make an offline payment to a merchant in a retail store through a credit card, debit card, digital wallet and the like.

The merchants are equipped with a point of sale machine or a device for performing offline transaction for accepting payments from the customers. Typically, the point of sale machine includes a magnetic strip card reader for allowing transaction through a digital payment card such as a debit card, credit card, gift card and the like. In addition, the point of sale machine may include a barcode reader and a QR code reader for generating purchase orders in real time. Moreover, the point of sale machine may be integrated with a barcode scanner and a QR code scanner. Nowadays, the customers have an option of making offline payment at merchant stores through a digital wallet. The digital wallet is associated with a mobile application installed on a portable communication device of the customer. Examples of the portable communication device include a smartphone, a tablet, a personal digital assistant and the like.

The customer accesses the mobile application associated with the digital wallet in real time on the portable communication device. The digital wallet stores payment information and personal information of the customer such as payment options, digital money added through a debit card or a credit card and the like. The customer may enter the merchant information on a payment interface of the mobile application in real time. Alternatively, the merchant may provide the customer with a QR code physically printed on a paper and fixed at a particular location at the merchant location. The QR code may be a static QR code. The QR code may be a dynamic QR code generated in real time. The dynamic QR code may contain information associated with the merchant, payment amount for the customer and the like. The customer may scan the QR code in real time through a QR code scanner on the mobile application and perform the payment.

The existing point of sale machines has limited applications when it comes to accepting payments through variety of digital payment solutions. The in-store merchants have to use different machines or POS terminals for accepting payment through different digital payment techniques. This increases investment cost for the merchants. The merchants are not equipped with a single point of sale device which can allow the merchants to accept payment through various digital wallets and digital payment techniques. Further, the existing point of sale machines hasn't been configured with the new age digital payment solutions. Furthermore, the current digital payment solutions are not scalable. The merchants are not ready to accept payments through traditional digital payment systems as well as new age digital payment solutions. Moreover, the existing systems do not provide or allow real time confirmation of payment when the merchant is away from the point of sale machine or terminal.

In light of the above stated discussion, there is a need for a system and point of sale terminal which overcomes the above stated disadvantages.

### SUMMARY

In a first example, the present disclosure provides a point of sale terminal. The point of sale terminal conducts a digital payment transaction between a customer and a merchant. In addition, the point of sale terminal enables the digital payment transaction through a plurality of digital payment modes. The point of sale terminal includes a graphical user interface screen. The graphical user interface screen allows the merchant and the customer to interact with the point of sale terminal in real time. In addition, the graphical user interface screen allows the merchant to select at least one digital payment mode of the plurality of digital payment modes for the customer. Moreover, the point of sale terminal includes a digital payment card swiping mechanism installed on the point of sale terminal. The digital payment card swiping mechanism allows the customer of a plurality of customers to perform the digital payment transaction. Further, the point of sale terminal includes a chip reader mechanism installed on the point of sale terminal. Furthermore, the point of sale terminal includes a biometric scanner for real time biometric verification of the customer. Also, the point of sale terminal includes software installed inside a hardware layer of the point of sale terminal. In addition, the point of sale terminal includes a printing mechanism. The printing mechanism allows auto-printing of one or more payment receipts in real time on completion of the digital payment transaction by the customer through at least one digital payment mode of the plurality of digital payment modes. The digital payment transaction is completed through the selected digital wallet application of the plurality of digital wallet applications installed on a portable communication device associated with the customer. The at least one digital payment mode is selected based on a choice of the customer in real time. The at least one digital payment mode is enabled through a digital wallet application of a plurality of digital wallet applications installed on the portable communication device associated with the customer. The digital payment transaction performed through the digital payment card is based on a choice of the customer. The biometric scanner is configured to accept a biometric input from the customer and prompt the customer to enter a unique identification number associated with the customer on the graphical user interface screen of the point of sale terminal. The unique identification number is linked to an account associated with at least one financial institution of a plurality of financial institutions. The software is configured to allow each merchant of a plurality of merchants to set up a payment collection and confirmation organization. The payment collection and confirmation organization includes a second set of information associated with at least one user of one or more users. The payment collection and confirmation organization is set up for authorization of the at least one user of the one or more users for reception of payment confirmation information in real time after the completion of the digital payment transaction in real time. The software is associated with a software application installed in the point of sale terminal. The software is configured to generate at least one of the quick response code and the barcode based on the payment request. The one or more payment receipts are printed for each type of digital payment mode in real time.

In an embodiment of the present disclosure, the printing mechanism includes a printer connected externally to the point of sale terminal.

In another embodiment of the present disclosure, the printing mechanism includes a printer connected internally to the point of sale terminal.

In an embodiment of the present disclosure, the graphical user interface screen being configured to display at least one of a quick response code and a barcode after receiving a payment request in real time the first set of information includes coded information about the merchant. The coded information includes merchant ID, an ID associated with the point of sale terminal, total amount to be paid by the customer to the merchant and an invoice number generated for the digital payment transaction.

In an embodiment of the present disclosure, the second set of information includes personal information associated with at least one user of the one or more users selected by the merchant to receive the payment confirmation information in real time. The personal information includes a name of the at least one user, a phone number associated with the at least one user and an e-mail address associated with the at least one user. In addition, the personal information includes a type of association with the merchant and a gender of the at least one user.

In an embodiment of the present disclosure, the quick response code generated by the software is a dynamic quick response code. The dynamic quick response code is generated in real time based on selection of the merchant and the customer to perform the digital transaction through generation of the quick response code.

In an embodiment of the present disclosure, the quick response code is a static quick response code. The static quick response code is physically printed on a printing media and placed in a vicinity of the point of sale terminal. The static quick response code contains coded information associated with the merchant. The static quick response code is scanned in real time by the customer through a quick response code scanning option associated with a digital wallet application for completion of the digital payment transaction.

In an embodiment of the present disclosure, the software installed on the point of sale terminal further performs filtering of one or more transactions in real time. The filtering is performed by collection of data associated with the one or more transactions in real time and analysis of the collected data associated with the one or more transactions in real time. The analysis is done by slicing and dicing the collected data to extract information about each of the one or more transactions.

In an embodiment of the present disclosure, the payment confirmation information is received by the at least one user based on a pre-determined criterion. The pre-determined criterion includes reception of the payment confirmation information after completion of the transaction when the merchant is unavailable at a point of sale location associated with the installed point of terminal. The payment confirmation information is received on a portable communication device associated with the at least one user of the one or more users. The payment confirmation information is received by the at least one user for a pre-defined range of time. The pre-defined range of time is set by the merchant in real time.

In an embodiment of the present disclosure, the plurality of digital payment modes include payment through credit card, payment through debit card and payment through scanning the quick response code. In addition, the plurality of digital payment modes includes payment through the biometric verification and entering the unique identification number and payment through loyalty points.

In a second example, the present disclosure provides a point of sale terminal. The point of sale terminal conducts a digital payment transaction between a customer and a merchant. In addition, the point of sale terminal enables the digital payment transaction through a plurality of digital payment modes. The point of sale terminal includes a graphical user interface screen. The graphical user interface screen allows the merchant and the customer to interact with the point of sale terminal in real time. In addition, the graphical user interface screen allows the merchant to select at least one digital payment mode of the plurality of digital payment modes for the customer. Moreover, the point of sale terminal includes a digital payment card swiping mechanism installed on the point of sale terminal. The digital payment card swiping mechanism allows the customer of a plurality of customers to perform the digital payment transaction. Further, the point of sale terminal includes a chip reader mechanism installed on the point of sale terminal. Furthermore, the point of sale terminal includes a biometric scanner for real time biometric verification of the customer. Also, the point of sale terminal includes software installed inside a hardware layer of the point of sale terminal. In addition, the point of sale terminal includes a printing mechanism. The printing mechanism allows auto-printing of one or more payment receipts in real time on completion of the digital payment transaction by the customer through at least one digital payment mode of the plurality of digital payment modes. The digital payment transaction is completed through the selected digital wallet application of the plurality of digital wallet applications installed on a portable communication device associated with the customer. The at least one digital payment mode is selected based on a choice of the customer in real time. The at least one digital payment mode is enabled through a digital wallet application of a plurality of digital wallet applications installed on the portable communication device associated with the customer. The graphical user interface screen is configured to display at least one of a quick response code and a barcode after receiving a payment request in real time. The quick response code contains a first set of information associated with the merchant. The digital payment transaction performed through the digital payment card is based on a choice of the customer. The biometric scanner is configured to accept a biometric input from the customer and prompt the customer to enter a unique identification number associated with the customer on the graphical user interface screen of the point of sale terminal. The unique identification number is linked to an account associated with at least one financial institution of a plurality of financial institutions. The software is configured to allow each merchant of a plurality of merchants to set up a payment collection and confirmation organization. The payment collection and confirmation organization includes a second set of information associated with at least one user of one or more users. The payment collection and confirmation organization is set up for authorization of the at least one user of the one or more users for reception of payment confirmation information in real time after the completion of the digital payment transaction in real time. The payment confirmation information is received by the at least one user based on a pre-determined criterion. The pre-determined criterion includes reception of the payment confirmation information after completion of the digital payment transaction when the merchant is unavailable at a point of sale location associated with the installed point of terminal. The software is associated with a software application installed in the point of sale terminal. The software is configured to generate at least one of the quick response code and the barcode based on the payment request. The one or more payment receipts are printed for each type of digital payment mode in real time.

### BRIEF DESCRIPTION OF THE FIGURES

Having thus described the invention in general terms, reference will now be made to the accompanying drawings, which are not necessarily drawn to scale, and wherein:

FIG. 1A illustrates an interactive computing environment for real time digital payment transaction between a merchant and a customer, in accordance with various embodiments of the present disclosure;

FIG. 1B illustrates a block diagram of a point of sale terminal, in accordance with various embodiments of the present disclosure; and

FIG. 2 illustrates the block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

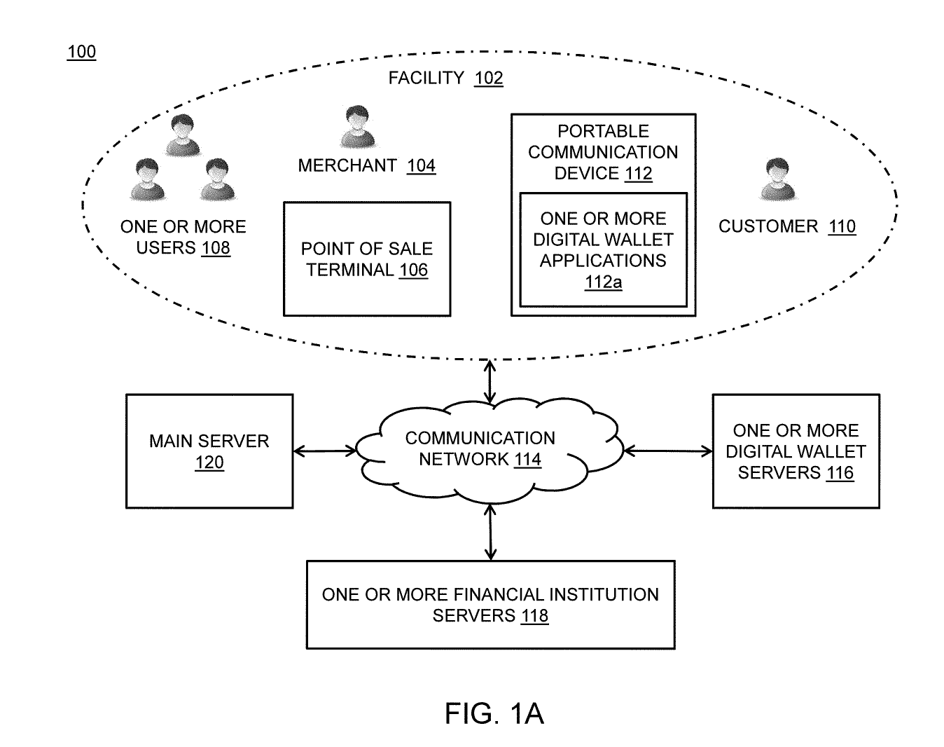

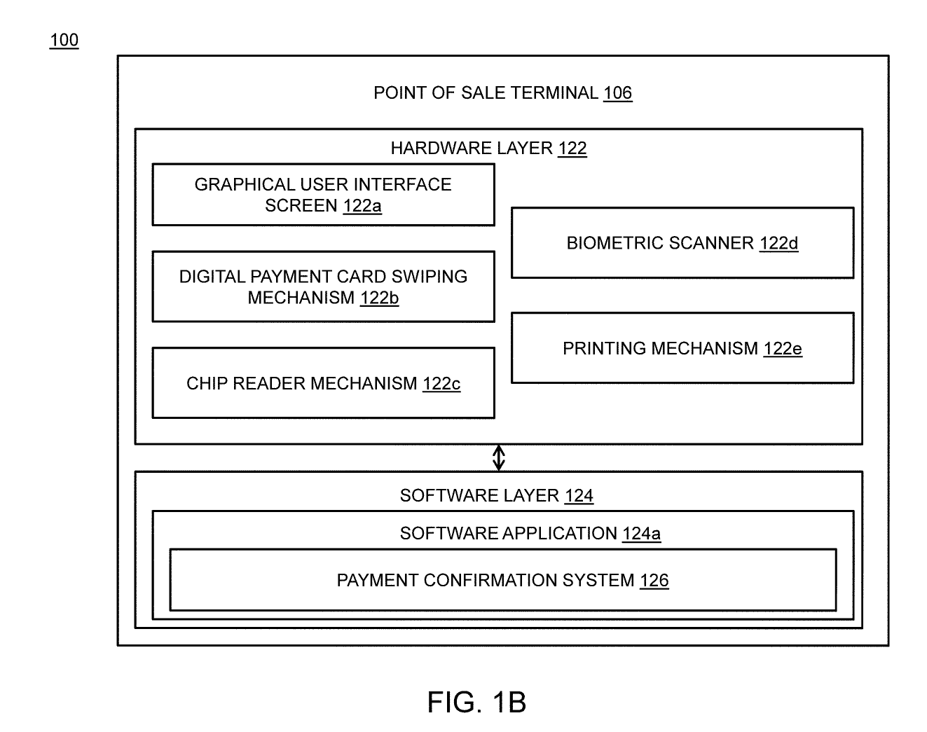

FIG. 1 illustrates an interactive computing environment 100 for enabling digital payment transaction between a merchant and a customer in real time, in accordance with various embodiments of the present disclosure. The digital payment transaction corresponds to transfer of funds from one account to another in real time. In addition, the digital payment transaction corresponds to use of digital payment techniques known in the art for transferring funds. Moreover, the digital payment transaction can be made at any offline store to the merchant. The digital payment transaction enables the customer to make swift and hassle free payment to the merchant without the need of carrying cash.

The digital payment transaction involves payment which can be made directly to the merchant through an account associated with a financial institution. The account belongs to the customer with a particular amount of money which can be used to make the payment offline and online. In addition, the digital payment transaction is made by following a pre-set rules and standards which must be followed whenever a transaction request is generated. In general, the customer utilizes various digital payment instruments for carrying out the digital payment transaction online and offline. The digital payment instruments include a debit card, a credit card and the like.

In an example, the customer may initiate a transaction at a retail store for buying groceries through a credit card or a debit card. The credit card or the debit card is associated with a particular financial institution which allows the customer to make payment. In another example, the customer may initiate a transaction at an online market store (e-commerce website) for buying electronic products (smartphone) through a debit card or a credit card. Further, the customer may make the digital payment by utilizing loyalty points which are provided by the merchant when the customer has made substantial payments in the past. The customer may utilize a handheld device for making the payment online and offline. The handheld device includes a smartphone, a tablet, a laptop, a personal digital assistant and the like.

In yet another example, the customer may make the offline and online payment through a digital wallet in real time. The digital wallet corresponds to an online wallet which allows the customer to make online and offline payments. The digital wallet is associated with a digital wallet application installed on a portable communication device associated with the customer. The customer accesses the digital wallet application in real time for making the digital payment. In addition, the digital wallet allows the customer to make payment through various digital payment modes. The digital payment modes include payment through quick response code generation, payment through fingerprint scanning and user identification number and the like.

The digital wallet is linked to a bank account of the customer. In addition, the digital wallet allows transfer of payment directly from one bank account to another in real time. Alternatively, the digital wallet allows the customer to transfer the payment from one digital wallet account to another in real time. The digital wallet may allow only the customer to either transfer the funds from one bank account to another or from one digital wallet account to another. The customer may access a digital wallet application which allows him or her to transfer funds directly from one bank account to another in real time. Further, a number of digital wallet systems are currently known in the art which allow the customer to transfer funds directly from one bank account to another in real time.

Going further, the interactive computing environment 100 includes a merchant 104, a point of sale terminal 106, one or more users 108, a customer 110 and a portable communication device 112. In addition, the interactive environment 100 includes a communication network 114, one or more digital wallet servers 116, one or more financial institution servers 118 and a main server 120. The interactive environment 100 enables the merchant 104 to accept digital payment from the customer 110 through multiple digital payment modes. In addition, the interactive computing environment 100 enables the merchant 104 to accept digital payment through any of the multiple digital payment modes through a single point of sale device.

Further, the interactive computing environment 100 enables the real time digital payment transaction between the merchant 104 and the customer 110. The merchant 104 and the customer 110 located in a facility 102 in real time. The facility 102 corresponds to any offline store, retail store, an office, a building, a factory, an airport and the like. In addition, the facility 102 corresponds to any type of location or venue where a digital payment transaction can be performed. In an example, the facility 102 is a retail store for buying clothes, shoes and accessories. In another example, the facility 102 is a ticket booking store or counter for booking tickets for buses, trains, flights, amusement parks, movies, plays and the like. In yet another example, the facility 102 is any type of service providing facility such as software services, repairing services, fitness related services and the like.

In an embodiment of the present disclosure, the facility 102 can be any place or location where a buying action can be performed by the customer 110 in real time. In an embodiment of the present disclosure, the facility 102 may be any kiosk set up by the merchant 104 for selling any product, service and the like. The merchant 104 may be any person or individual who conducts a real time digital payment transaction with the customer 110. In an example, the merchant 104 may be an owner of the facility 102, an employee at the facility 102 and the like. The merchant 104 is an authorized dealer for providing various goods and services at fixed or variable prices to the customer 110. In an embodiment of the present disclosure, the merchant 104 does not need to be present at the counter. In an example, the counter may be an auto checkout counter without the need of a man.

In an embodiment of the present disclosure, the merchant 104 is currently present inside the facility 102. In another embodiment of the present disclosure, the merchant 104 is located at some distance from the facility 102. In yet another embodiment of the present disclosure, the merchant 104 is located away from the facility 102 in real time. In an example, the merchant 104 may have some errands to complete or may have gone out for some official work or personal work.

Going further, the merchant 104 is associated with the point of sale terminal 106. In an embodiment of the present disclosure, the merchant 104 is located near the point of sale terminal 106 in real time. In an embodiment of the present disclosure, the merchant 104 is located near the point of sale terminal 106 in real time. In another embodiment of the present disclosure, the merchant 104 is located at a considerable distance from the point of sale terminal 104. In an example, the merchant 104 is seated at a checkout counter of a retail clothing store in real time.

The point of sale terminal 106 is a device for carrying out the digital payment transaction in real time. In addition, the point of sale terminal 106 can accept people to business (P2B) payments and send business to people (B2P) or business to business (B2B) payments. The point of sale terminal 106 handles retail store financial transactions, business related transactions, personal transactions and the like. In addition, the point of sale terminal 106 allows the merchant 104 to accept payment through a plurality of digital payment modes in real time. Moreover, the point of sale terminal 106 provides a mechanism for accepting payment without need of additional devices. Further, the point of sale terminal 106 is a combination of a hardware layer 122 and a software layer 124. The hardware layer 122 includes a plurality of hardware elements. The software layer 124 is associated with the software for allowing the merchant 104 to perform the digital payment transaction. The combination of the hardware layer 122 and the software layer 124 enables the merchant 104 to accept payment through the plurality of digital payment modes in real time.

The plurality of hardware elements are embedded inside the point of sale terminal 106. Each of the plurality of hardware elements function according to one or more instructions provided by the software in real time. In addition, each of the plurality of hardware elements follow coded instructions which are pre-programmed into the point of sale terminal 106. Each of the plurality of hardware elements perform a specific task for carrying out the digital payment transaction in real time. The plurality of hardware elements include a graphical user interface screen 122a, a digital payment card swiping mechanism 122b, a chip reader mechanism 122c, a biometric scanner 122d and a printing mechanism 122e (explained below in the patent application). In an embodiment, the plurality of hardware elements includes NFC readers, sound wave detectors and the like.

Each of the plurality of hardware elements in linked with the software. The software is embedded inside the point of sale terminal 106. The software contains a set of coded instructions for carrying out the digital payment transaction. Each set of coded instructions is different for each type of digital payment mode. Further, the software runs on a specific type of operating system. The operating system includes DOS operating system, Windows operating system, Linux operating system, Unix operating system, MAC operating system and the like.

Further, the software is associated with a software application 124a installed in the point of sale terminal 106. The software application 124a is compatible with a specific type of operating system on which the point of sale terminal 106 runs. In an embodiment of the present disclosure, the software application 124a may be pre-installed in the point of sale terminal 106 by a manufacturer or an administrator. In another embodiment of the present disclosure, the software application 124a may be installed by the merchant 104. The merchant 104 may access the software application 124a in real time on the point of sale terminal 106 through the graphical user interface screen.

The point of sale terminal 106 is connected to internet in real time. In an embodiment of the present disclosure, the point of sale terminal 106 is connected to the internet through the communication network 114. In an embodiment of the present disclosure, the point of sale terminal 106 may be connected through a WiFi connection. In another embodiment of the present disclosure, the point of sale terminal 106 may be connected through an Ethernet port. In yet another embodiment of the present disclosure, the point of sale terminal 106 may be connected through a bluetooth connection. The point of sale terminal 106 is associated with a static IP address which is used for connecting to the internet. The merchant 104 signs up or registers on a web based platform associated with the software application 124a for accepting the digital payment from the customer 110. The merchant 104 may provide a set of information on the web based platform in real time for signing up as a merchant. The set of information may include name, e-mail address, phone number, address, a type of business, a location of a retail store, address of the retail store, number of employees and the like. The merchant 104 logs in to an account on the web based platform. In addition, the merchant 104 may configure the software application 124a as per business requirements or needs.

The merchant 104 is associated with a portable communication device. Examples of the portable communication device include but may not be limited to smartphone, laptop, tablet and personal digital assistant. The portable communication device is connected to the internet in real time. In an embodiment of the present disclosure, the portable communication device is connected to the internet through the communication network 114. Further, the portable communication device is connected to the internet through a data connection provided by a telecom service provider. The telecom service provider is associated with a subscriber identification module card located inside the portable communication device. Furthermore, the portable communication device may be connected to the internet through a WiFi connection.

Further, the portable communication device is associated with a specific type of operating system. The specific type of operating system includes an android operating system, a windows operating system, a mac operating system, symbian operating system and the like. In an embodiment of the present disclosure, the merchant 104 may access a software application associated with the software of the on the portable communication device. The software application is installed on the portable communication device of the merchant 104.

In an embodiment of the present disclosure, the merchant 104 may access a browser application on the portable communication device. The merchant 104 may access a website associated with the point of sale terminal 106. The website provides a web based platform to the merchant 104. The merchant 104 may sign up on the web based platform through the website. The merchant 104 may provide the set of information on the web based platform for registering on the web based platform. The web based platform enables the merchant 104 to set priorities as per the business needs and requirements.

Going further, the merchant 104 is associated with the one or more users 108. In addition, the one or more users 108 are associated with the point of sale terminal 106. The one or more users 108 are located in the facility 102 in real time. The one or more users 108 are in a vicinity of the merchant 104 and the point of sale terminal 106 in real time. The one or more users 108 may be any person or individual who have a permission to accept the digital payment on behalf of the merchant 104 in real time. The one or more users 108 may be a relative, a colleague, a friend, an employee or any other person in relation to the merchant 104. In an example, the merchant 104 may allow a relative (say a brother) to accept the digital payment on his or her behalf for a specific duration of time (say 2 pm to 3 pm).

Going further, the customer 110 is located inside the facility 102 in real time. The customer 110 is any person or individual looking to buy one or more products, one or more services or any other transaction related activity in real time. In an example, the customer 110 wants to buy one or more footwear products (say shoes and flip flops). The customer 110 is associated with the portable communication device 112. The customer 110 is an owner of the portable communication device 112. Examples of the portable communication device 112 include a smartphone, a tablet, a laptop, a personal digital assistant and the like.

The portable communication device 112 is connected to the internet in real time. In an embodiment of the present disclosure, the portable communication device 112 is connected to the internet through the communication network 114. Further, the portable communication device 112 is connected to the internet through a data connection provided by a telecom service provider. The telecom service provider is associated with a subscriber identification module card located inside the portable communication device 112. Furthermore, the portable communication device 112 may be connected to the internet through a WiFi connection.

Further, the portable communication device 112 is associated with a specific type of operating system. The specific type of operating system includes an android operating system, a windows operating system, a mac operating system, symbian operating system and the like. The portable communication device 112 includes one or more digital wallet applications 112a. The one or more digital wallet applications 112a are installed in the portable communication device 112. The one or more digital wallet applications 112a are compatible with an operating system associated with the portable communication device 112. The one or more digital wallet applications 112a enable the customer 110 to perform a cashless transaction through the plurality of digital payment modes.

The customer 110 may select any one of the one or more digital wallet applications 112a in real time for performing the digital payment transaction. Further, each of the one or more digital wallet applications 112a is linked with a corresponding server of the one or more digital wallet servers 116. Furthermore, each of the one or more digital wallet applications 112a is linked with the corresponding server of the one or more digital wallet servers 116 through the communication network 114. The one or more digital wallet servers 116 enable real time transfer of funds from one account to another. The one or more digital wallet servers 116 handle various operations performed by the one or more digital wallet applications.

The customer 110 registers on the one or more digital wallet applications 112a. The customer 110 enters personal information on an interface of the one or more digital wallet applications 112a. The personal information includes name, gender, age, e-mail address, phone number and the like. In addition, the customer 110 provides payment information on the one or more digital wallet applications 112a. The payment information includes one or more bank account details, one or more credit card details, one or more debit card details and the like. The details include a name of a financial institution where the customer 110 has an account, a type of account, an account number, a location of branch of the financial institution and the like.

The one or more digital wallet servers 116 are linked with the one or more financial institution servers 118 through the communication network 114. The one or more financial institution servers 118 store account related information of the customer 110. The one or more digital wallet servers 116 send a request to the one or more financial institution servers 118. The request is sent for verification of the account information and payment information of the customer 110 when the customer 110 initiates a transaction. The one or more financial institution servers 118 receive the request as a query and verify the information and send an acknowledgement to the one or more digital servers 116.

Going further, the point of sale terminal 106 is linked with the main server 120. In addition, the main server 120 is linked with the one or more digital servers 116 and the one or more financial institution servers 118 though the communication network 114. The main server 120 handles various operations performed by the point of sale terminal 106. The operations include registration of the merchant 104, payment confirmation information transmission, verification of payment confirmation for the customer 110 and the like. The main server 120 is located remotely from the point of sale terminal 106.

The merchant 104 sets up a payment collection and confirmation organization on the web based platform. In an embodiment of the present disclosure, the merchant 104 may set up the payment collection and confirmation organization directly on the point of sale terminal 106. The point of sale terminal 106 provides a dashboard interface to the merchant 104. The dashboard interface allows the merchant 104 to specify at least one user of the one or more users 108 authorized to collect payment and confirm the payment on completion.

The merchant 104 sets up the payment collection and confirmation organization through the software associated with the point of sale terminal 106. In addition, the software associated with the software application 124a includes a payment confirmation system 126. The payment confirmation system 126 allows the merchant 104 to set up the payment collection and confirmation organization. The software is configured to allow each merchant of a plurality of merchants to set up the payment collection and confirmation organization. The payment collection and confirmation organization includes a second set of information associated with at least one user of one or more users 108. In an embodiment of the present disclosure, the second set of information may include personal information associated with at least one user of the one or more users 108. The at least one user is selected by the merchant 104 to receive the payment confirmation information in real time. The merchant 104 provides the second set of information on the web based platform.

The personal information includes a name of the at least one user, a phone number associated with the at least one user and an e-mail address associated with the at least one user. In addition, the personal information includes a type of association with the merchant 104 and a gender of the at least one user. The at least one user of the one or more users 108 is selected based on a choice of the merchant 104. The payment collection and confirmation organization is set up for authorization of the at least one user of the one or more users 108. The authorization is done for reception of payment confirmation information in real time after the completion of the digital payment transaction in real time.

The payment confirmation information is received by the at least one user based on a pre-determined criterion. In an embodiment of the present disclosure, the pre-determined criterion includes reception of the payment confirmation information after completion of the transaction. The payment confirmation information is received when the merchant 104 is unavailable at a point of sale location associated with the installed point of sale terminal 106. The payment confirmation information is received on a portable communication device associated with the at least one user of the one or more users 108. The payment confirmation information is received by the at least one user for a pre-defined range of time. The pre-defined range of time is set by the merchant in real time. In an example, the merchant 104 may set a time of 1 pm-2 pm where any user registered on the platform as a payment collector on behalf of the merchant 104 can accept and confirm receipt of payment.

Further, the customer 110 visits the facility 102 for buying one or more products, one or more services or any other transaction related activity. In an example, the customer 110 selects one or more clothing related products (say t-shirts, jeans and the like) and proceeds to a checkout counter for payment. In an embodiment of the present disclosure, the customer 110 may choose to pay cash. In another embodiment of the present disclosure, the customer 110 may choose to pay through any digital payment mode. The point of sale terminal 106 is installed at the checkout counter where the merchant 104 is present. The merchant 104 may not be present at the checkout counter and the at least one user of the one or more users 108 may be present at the checkout counter to accept and confirm the payment on behalf of the merchant 104. The graphical user interface screen 122a allows the merchant 104 and the customer 110 to interact with the point of sale terminal 106 in real time. The graphical user interface screen 122a is a high resolution screen of a pre-defined size and dimensions. In addition, the point of sale terminal 106 allows the merchant 104 to select at least one digital payment mode of the plurality of digital payment modes for the customer 110. In addition, the graphical user interface screen 122a is configured to display at least one of a quick response code and a barcode after receiving a payment request in real time.

The at least one digital payment mode may be selected based on a choice of the customer 110 in real time. In an embodiment of the present disclosure, the point of sale terminal 106 may display a list of the plurality of digital payment modes on the graphical user interface screen 122a. The merchant 104 may ask the customer 110 to select at least one digital payment mode of the plurality of digital payment modes displayed on the graphical user interface screen 122a. The plurality of digital payment modes includes payment through credit card, payment through debit card and payment through scanning the quick response code. In addition, the plurality of digital payment modes includes payment through the biometric verification and entering the unique identification number and payment through loyalty points. Moreover, the plurality of digital payment modes includes payment through Unified Payments Interface (UPI) mode.

The customer 110 accesses a digital wallet application of the one or more digital wallet applications 112a on the portable communication device 112 in real time. The digital wallet application is enabled for performing the digital payment transaction through any of the plurality of digital payment modes. In an embodiment of the present disclosure, the digital wallet application is provided directly by a corresponding financial institution. In another embodiment of the present disclosure, the digital wallet application may be provided by a third party vendor who acts as an interface between the customer 110 and the corresponding financial institution.

In an example, a customer A, a customer B and a customer C enter a clothing store Z. The customer A selects a product L (say t shirt), the customer B selects a product M (say formal pants) and the customer C selects a product N (say jeans). The customers A, B and C proceed for payment at checkout counter. A merchant Z1 is located at the checkout counter and a point of sale terminal P is installed at the checkout counter. The customer A wants to make payment through a debit card, the customer B wants to make payment through quick response code scanning and the customer C wants to make payment through fingerprint scanning and unique identification number verification. The merchant Z1 selects option for the customers A, B and C on the point of sale terminal P. The customer A has a portable communication device A1, the customer B has a portable communication device B1 and the customer C has a portable communication device C1. The customer A accesses a digital wallet application D1 on the portable communication device A1, the customer B accesses a digital wallet application D2 on the portable communication device B1 and the customer C accesses a digital wallet application D3 on the portable communication device C1.

Further, the point of sale terminal 106 includes the digital payment card swiping mechanism 122b. The digital payment card swiping mechanism 122b allows the customer 110 of a plurality of customers to perform the digital payment transaction by swiping a digital payment card of a plurality of digital payment cards. The merchant 104 may take the digital payment card from the customer 110 and swipe the digital payment card on the digital payment card swiping mechanism 122b. The point of sale terminal 106 reads information associated with the customer 110 through magnetic strip reading as known in the art. In an embodiment of the present disclosure, the digital payment card swiping mechanism 122b may be installed at any suitable location on the point of sale terminal 106.

Furthermore, the point of sale terminal 106 includes the chip reader mechanism 122c. The chip reader mechanism 122c may be located at any suitable location on the point of sale terminal 106. In an example, the chip reader mechanism 122c may be located at a lower end of the point of sale terminal 106. The chip reader mechanism 122c includes a slot for inserting the digital payment card associated with the customer 110. The chip reader mechanism 122c allows the merchant 104 to insert the digital payment card of the plurality of digital payment cards equipped with a smart computer chip. In addition, the chip reader mechanism 122c allows the point of sale terminal 106 to read information associated with the customer 110 and the digital payment card in real time for performing the digital payment transaction.

Going further, the point of sale terminal 106 includes the biometric scanner 122d for real time biometric verification of the customer 110. The biometric scanner 122d may be located at any suitable location on the point of sale terminal 106. In an example, the biometric scanner 122d may be located at a top end of the point of sale terminal 106. In an embodiment of the present disclosure, the biometric scanner 122d may be embedded inside the point of sale terminal 106. The biometric scanner 122d may be linked with the software application 124a.

The biometric scanner 122d is configured to accept a biometric input from the customer 110. Accordingly, the point of sale terminal 106 prompts the customer 110 to enter a unique identification number associated with the customer 110 on the graphical user interface screen 122a of the point of sale terminal 106. The unique identification number is linked to an account associated with at least one financial institution of a plurality of financial institutions. The financial institution corresponds to a commercial bank, an investment bank, nonbank financial institutions and the like. In an embodiment of the present disclosure, the biometric input is a fingerprint of the customer 110. In another embodiment of the present disclosure, the biometric input may be any other type of biometric identity of the customer 110.

In an embodiment of the present disclosure, the customer 110 may input the biometric input on the graphical user interface screen 122a. The software application 124a may present a user interface for entering the biometric input on the graphical user interface screen 122a. The biometric input may be entered directly on the graphical user interface screen 122a. In addition, the unique identification number is entered on the graphical user interface screen 122a. The unique identification number is at least one of a numeric code, an alphanumeric code and the like. The unique identification number is issued by a government authority with pre-stored data related to fingerprints and retina scans of the plurality of customers. In another example, a customer A carries a unique identification card (Aadhar Card) with QR code printed on the card. The point of sale terminal 106 can read the QR code and the customer A can validate his or her authentication using the biometric scanner.

The point of sale terminal 106 includes the printing mechanism 122e. The printing mechanism 122e allows auto-printing of one or more payment receipts in real time on completion of the digital payment transaction by the customer 110. The digital payment transaction is done through at least one digital payment mode of the plurality of digital payment modes. The one or more payment receipts are printed for each type of digital payment mode in real time. In an embodiment of the present disclosure, the printing mechanism 122e includes a printer connected externally to the point of sale terminal 106. In another embodiment of the present disclosure, the printing mechanism 122e includes a printer connected internally to the point of sale terminal 106.

In an embodiment of the present disclosure, the customer 110 may select the option of payment through the digital payment card in real time. The customer 110 provides his or her digital payment card to the merchant 104. Accordingly, the merchant 104 can select whether to swipe the card on the digital payment card swiping mechanism 122b or insert the card on the slot associated with the chip reader mechanism 122c. In an embodiment of the present disclosure, the merchant 104 swipes the digital payment card on the digital payment card swiping mechanism 122b and proceeds with the digital payment transaction. The customer 110 may enter the information related to the digital payment card on the graphical user interface screen 122a. The information includes a pin number, a CVV code and the like. In another embodiment of the present disclosure, the merchant 104 inserts the digital payment card on the slot of the chip reader mechanism 122c and proceeds with the digital payment transaction. The chip reader mechanism 122c reads data encrypted in the smart computer chip. The customer 110 may enter the information related to the digital payment card on the graphical user interface screen 122a. The information includes a pin number, a CVV code and the like. The software associated with the point of sale terminal 106 verifies the information entered by the customer 110 by sending a request to the one or more financial institution servers 118. The one or more financial institution servers 118 verify the information and send an acknowledgement to proceed with the transaction. The point of sale terminal 106 auto-prints a payment receipt of the digital payment transaction after the payment is transferred.

In another embodiment of the present disclosure, the customer 110 may select the option of payment through biometric verification and unique identification number verification. The merchant 104 selects the option of payment through the biometric verification and unique identification number verification on the graphical user interface screen 122a. The customer 110 enters the unique identification number on the graphical user interface screen 122a. Further, the software determines one or more accounts of the customer 110 in the corresponding one or more financial institutions with which the unique identification number is linked. The customer 110 selects an account of the one or more accounts on the graphical user interface screen 122a and proceeds with the transaction. Accordingly, the customer 110 provides the biometric input on the biometric scanner 122d of the point of sale terminal 106 linked to the selected account. In an example, the customer 110 keeps a finger (say, index finger) on the biometric scanner 122d. The biometric scanner 122d records the biometric input (fingerprint) of the customer 110. The software associated with the point of sale terminal 106 matches the biometric input with pre-stored biometric inputs of a plurality of customers in real time. The pre-stored biometric inputs are accessed through a database associated with the one or more financial institution servers 118. The pre-stored biometric inputs may be accessed through a database associated with a server of the government authority who issued the unique identification number to the customer 110. The software receives information related to confirmation of identity of the customer 110 in real time. Accordingly, the software proceeds with the transaction after verification of the information. In an embodiment of the present disclosure, the payment is transferred directly to the bank account of the merchant 104. In addition, the printing mechanism 122e auto-prints the payment receipt of the digital payment transaction after the payment is transferred.

In yet another embodiment of the present disclosure, the customer 110 may select the option of payment through quick response code scanning. The merchant 104 selects the option of payment through the quick response code scanning on the graphical user interface screen 122a. The merchant 104 enters the amount of payment to be made by the customer 110 and generates a quick response code in real time. The quick response code contains a first set of information associated with the merchant 104. In an embodiment of the present disclosure, the first set of information includes coded information about the merchant 104. The coded information includes merchant ID, an ID associated with the point of sale terminal 106, total amount to be paid by the customer 110 to the merchant 104 and an invoice number generated for the digital payment transaction. In an embodiment of the present disclosure, the quick response code generated by the software is a dynamic quick response code. The dynamic quick response code is generated in real time based on selection of the merchant 104 and the customer 110 to perform the digital transaction through generation of the quick response code. In another embodiment of the present disclosure, the quick response code is a static quick response code. The static quick response code is physically printed on a printing media and placed in a vicinity of the point of sale terminal 106. The static quick response code contains coded information associated with the merchant 104. The static quick response code is scanned in real time by the customer 110 through a quick response code scanning option associated with a digital wallet application for completion of the digital payment transaction.

The customer 110 accesses a QR code scanning feature on the digital wallet application of the one or more digital wallet applications 112a on the portable communication device 112. The customer 110 scans the quick response code in real time. The QR code scanning feature reads the first set of information associated with the quick response code. Accordingly, the customer 110 may enter payment information after scanning the quick response code on the interface of the digital wallet application. The payment information includes information related to digital payment card such as pin number, CW number, a unique password and the like. The one or more digital wallet servers 116 verify the information by sending a request to a server of the one or more financial institution servers 118. The request is received and the information is verified by the server of the corresponding financial institution. Accordingly, the software proceeds with the transaction after verification of the information. In an embodiment of the present disclosure, the payment is transferred directly to the bank account of the merchant 104. In addition, the printing mechanism 122e auto-prints the payment receipt of the digital payment transaction after the payment is transferred.

In yet another embodiment of the present disclosure, the customer 110 may select the option of payment through Unified Payments Interface. The customer 110 may enter information about the merchant 104 to whom the payment needs to be made along with the payment amount. In addition, the customer 110 enters a unique UPI pin on an interface of the point of sale terminal 106 and clicks on submit. Accordingly, the payment is complete and transferred from a bank account of the customer 110 directly to a bank account of the merchant 104.

In an embodiment of the present disclosure, the customer 110 may initiate payment directly from the portable communication device 112. The payment confirmation can be routed from the connecting logic or network to the point of sale terminal 106. In an example, the customer 110 can initiate transaction by inputting merchant ID or scanning a QR code and the authentication can take place on the portable communication device 112.

In an embodiment of the present disclosure, the point of sale terminal 106 can be operated offline for collecting payments. The offline operation is done by connecting or mapping a printed card with the point of sale terminal 106. In an example, the point of sale terminal 106 prints a receipt or bill which has a QR code which can be scanned by a customer from a mobile device using any mobile wallet application to make payment. The payment confirmation is confirmed on the point of sale terminal 106 in real time. In addition, a pre-printed card may act as an extension of POS. In another example, a delivery boy going to deliver some stuff to a customer may ask the customer to pay using scanning a QR code on a visiting card of the delivery boy. The payment confirmation is routed to both the delivery boy and the POS machine.

In yet another example, the customer can scan a QR code printed on a shopping material and the payment confirmation takes place on the point of sale terminal 106. In yet another example, a printed advertisement may include a QR code and any customer can scan and pay to buy the material advertised. The payment is confirmed on the POS machine.

In an embodiment of the present disclosure, the point of sale terminal 106 can handle pre-approved payments. In an example, a customer with knowledge of an amount of payment to be made to a merchant can pre-pay the exact amount. The customer may confirm the payment on the point of sale terminal using either an OTP or by getting a QR code generated by a corresponding digital wallet provider and scanned on the POS machine.

Further, the software installed on the point of sale terminal 106 performs filtering of one or more transactions in real time. The filtering is performed by collection of data associated with the one or more transactions in real time and analysis of the collected data associated with the one or more transactions in real time. The analysis is done by slicing and dicing the collected data to extract information about each of the one or more transactions.

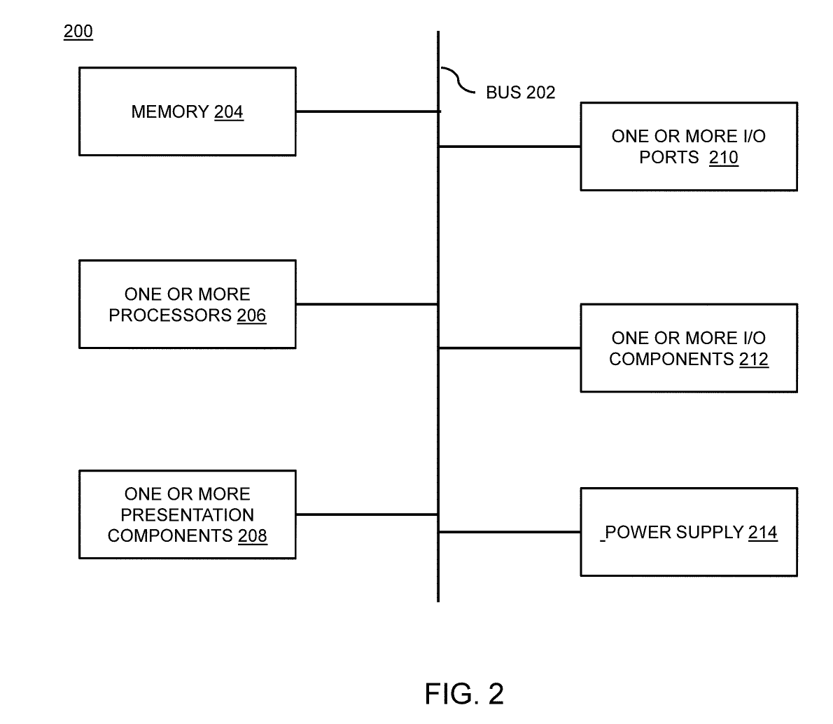

FIG. 2 illustrates the block diagram of a computing device 200, in accordance with various embodiments of the present disclosure. The computing device 200 includes a bus 202 that directly or indirectly couples the following devices: memory 204, one or more processors 206, one or more presentation components 208, one or more input/output (I/O) ports 210, one or more input/output components 212, and an illustrative power supply 214. The bus 202 represents what may be one or more busses (such as an address bus, data bus, or combination thereof). Although the various blocks of FIG. 2 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 2 is merely illustrative of an exemplary computing device 200 that can be used in connection with one or more embodiments of the present invention. Distinction is not made between such categories as “workstation,” “server,” “laptop,” “hand-held device,” etc., as all are contemplated within the scope of FIG. 2 and reference to “computing device.”

The computing device 200 typically includes a variety of computer-readable media. The computer-readable media can be any available media that can be accessed by the computing device 200 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 200. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 204 includes computer-storage media in the form of volatile and/or nonvolatile memory. The memory 204 may be removable, non-removable, or a combination thereof. Exemplary hardware devices include solid-state memory, hard drives, optical-disc drives, etc. The computing device 200 includes one or more processors that read data from various entities such as memory 204 or I/O components 212. The one or more presentation components 208 present data indications to a user or other device. Exemplary presentation components include a display device, speaker, printing component, vibrating component, etc. The one or more I/O ports 210 allow the computing device 200 to be logically coupled to other devices including the one or more I/O components 212, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A point of sale terminal for conducting a digital payment transaction between a customer and a merchant, the point of sale terminal enables the digital payment transaction through a plurality of digital payment modes, the point of sale terminal comprising:
a graphical user interface screen for allowing the merchant and the customer to interact with the point of sale terminal in real time and allow the merchant to select at least one digital payment mode of the plurality of digital payment modes for the customer, wherein the at least one digital payment mode being selected based on a choice of the customer in real time, wherein the at least one digital payment mode being enabled through a digital wallet application of a plurality of digital wallet applications installed on a portable communication device associated with the customer;
a digital payment card swiping mechanism installed on the point of sale terminal for allowing the customer of a plurality of customers to perform the digital payment transaction through a digital payment card, wherein the digital payment transaction performed through the digital payment card being based on a choice of the customer;
a chip reader mechanism installed on the point of sale terminal;
a biometric scanner for real time biometric verification of the customer, wherein the biometric scanner being configured to accept a biometric input from the customer and prompting the customer to enter a unique identification number associated with the customer on the graphical user interface screen of the point of sale terminal, wherein the unique identification number being linked to an account associated with at least one financial institution of a plurality of financial institutions;
a software installed inside a hardware layer of the point of sale terminal, wherein the software being configured to allow each merchant of a plurality of merchants to set up a payment collection and confirmation organization, wherein the payment collection and confirmation organization comprises a second set of information associated with at least one user of one or more users for authorizing the at least one user of the one or more users for collecting payment and receiving payment confirmation information in real time after the completion of the digital payment transaction in real time and wherein the software being configured to generate at least one of a quick response code and a barcode based on the payment request; and
a printing mechanism for allowing auto-printing of one or more payment receipts in real time on completion of the digital payment transaction by the customer through at least one digital payment mode of the plurality of digital payment modes through the selected digital wallet application of the plurality of digital wallet applications installed on the portable communication device, wherein the one or more payment receipts being printed for each type of digital payment mode in real time.

2. The point of sale terminal as recited in claim 1, wherein the printing mechanism comprises a printer connected externally to the point of sale terminal.

3. The point of sale terminal as recited in claim 1, wherein the printing mechanism comprises a printer connected internally to the point of sale terminal.

4. The point of sale terminal as recited in claim 1, wherein the graphical user interface screen being configured to display at least one of the quick response code and the barcode after receiving a payment request in real time and wherein the quick response code contains a first set of information associated with the merchant, wherein the first set of information comprises coded information about the merchant, wherein the coded information comprises merchant ID, an ID associated with the point of sale terminal, total amount to be paid by the customer to the merchant and an invoice number generated for the digital payment transaction.

5. The point of sale terminal as recited in claim 1, wherein the second set of information comprises personal information associated with at least one user of the one or more users selected by the merchant to receive the payment confirmation information in real time, wherein the personal information comprises a name of the at least one user, a phone number associated with the at least one user, an e-mail address associated with the at least one user, a type of association with the merchant and a gender of the at least one user.

6. The point of sale terminal as recited in claim 1, wherein the quick response code generated by the software being a dynamic quick response code, wherein the dynamic quick response code being generated in real time based on selection of the merchant and the customer to perform the digital transaction through generation of the quick response code.

7. The point of sale terminal as recited in claim 1, wherein the quick response code being a static quick response code, wherein the static quick response code being physically printed on a printing media and placed in a vicinity of the point of sale terminal, wherein the static quick response code contains coded information associated with the merchant and wherein the static quick response code being scanned in real time by the customer through a quick response code scanning option associated with a digital wallet application for completion of the digital payment transaction.

8. The point of sale terminal as recited in claim 1, wherein the software installed on the point of sale terminal further performs filtering of one or more transactions in real time, wherein the filtering being performed by:
collecting data associated with the one or more transactions in real time; and
analyzing the collected data associated with the one or more transactions in real time, wherein the analyzing being done by slicing and dicing the collected data to extract information about each of the one or more transactions.

9. The point of sale terminal as recited in claim 1, wherein the payment confirmation information being received by the at least one user based on a pre-determined criterion, wherein the software being associated with a software application installed in the point of sale terminal, wherein the pre-determined criterion comprises receiving the payment confirmation information after completion of the transaction when the merchant being unavailable at a point of sale location associated with the installed point of terminal, wherein the payment confirmation information being received on a portable communication device associated with the at least one user of the one or more users, wherein the payment confirmation information being received by the at least one user for a pre-defined range of time and wherein the pre-defined range of time being set by the merchant in real time.

10. The point of sale terminal as recited in claim 1, wherein the plurality of digital payment modes comprises payment through credit card, payment through debit card, payment through scanning the quick response code, payment through the biometric verification and entering the unique identification number and payment through loyalty points.

11. A point of sale terminal for conducting a digital payment transaction between a customer and a merchant, the point of sale terminal enables the digital payment transaction through a plurality of digital payment modes, the point of sale terminal comprising:
a graphical user interface screen for allowing the merchant and the customer to interact with the point of sale terminal in real time and allow the merchant to select at least one digital payment mode of the plurality of digital payment modes for the customer, wherein the at least one digital payment mode being selected based on a choice of the customer in real time, wherein the at least one digital payment mode being enabled through a digital wallet application of a plurality of digital wallet applications installed on a portable communication device associated with the customer, wherein the graphical user interface screen being configured to display at least one of a quick response code and a barcode after receiving a payment request in real time and wherein the quick response code contains a first set of information associated with the merchant;
a digital payment card swiping mechanism installed on the point of sale terminal for allowing the customer of a plurality of customers to perform the digital payment transaction, wherein the digital payment transaction performed through the digital payment card being based on a choice of the customer;
a chip reader mechanism installed on the point of sale terminal;
a biometric scanner for real time biometric verification of the customer, wherein the biometric scanner being configured to accept a biometric input from the customer and prompting the customer to enter a unique identification number associated with the customer on the graphical user interface screen of the point of sale terminal, wherein the unique identification number being linked to an account associated with at least one financial institution of a plurality of financial institutions;
a software installed inside a hardware layer of the point of sale terminal, wherein the software being configured to allow each merchant of a plurality of merchants to set up a payment collection and confirmation organization, wherein the payment collection and confirmation organization comprises a second set of information associated with at least one user of one or more users for authorizing the at least one user of the one or more users for collecting payment and receiving payment confirmation information in real time after the completion of the digital payment transaction in real time, wherein the payment confirmation information being received by the at least one user based on a pre-determined criterion, wherein the pre-determined criterion comprises receiving the payment confirmation information after completion of the digital payment transaction when the merchant being unavailable at a point of sale location associated with the installed point of terminal, wherein the software being associated with a software application installed in the point of sale terminal and wherein the software being configured to generate at least one of the quick response code and the barcode based on the payment request; and
a printing mechanism for allowing auto-printing of one or more payment receipts in real time on completion of the digital payment transaction by the customer through at least one digital payment mode of the plurality of digital payment modes through the selected digital wallet application of the plurality of digital wallet applications installed on the portable communication device, wherein the one or more payment receipts being printed for each type of digital payment mode in real time.

12. The point of sale terminal as recited in claim 11, wherein the printing mechanism comprises a printer connected externally to the point of sale terminal.

13. The point of sale terminal as recited in claim 11, wherein the printing mechanism comprises a printer connected internally to the point of sale terminal.

14. The point of sale terminal as recited in claim 11, wherein the first set of information comprises coded information about the merchant, wherein the coded information comprises merchant ID, an ID associated with the point of sale terminal, total amount to be paid by the customer to the merchant and an invoice number generated for the digital payment transaction.

15. The point of sale terminal as recited in claim 11, wherein the second set of information comprises personal information associated with at least one user of the one or more users selected by the merchant to receive the payment confirmation information in real time, wherein the personal information comprises a name of the at least one user, a phone number associated with the at least one user, an e-mail address associated with the at least one user, a type of association with the merchant and a gender of the at least one user.

16. The point of sale terminal as recited in claim 11, wherein the quick response code generated by the software being a dynamic quick response code, wherein the dynamic quick response code being generated in real time based on selection of the merchant and the customer to perform the digital transaction through generation of the quick response code.

17. The point of sale terminal as recited in claim 11, wherein the quick response code being a static quick response code, wherein the static quick response code being physically printed on a printing media and placed in a vicinity of the point of sale terminal, wherein the static quick response code contains coded information associated with the merchant and wherein the static quick response code being scanned in real time by the customer through a quick response code scanning option associated with a digital wallet application for completion of the digital payment transaction.

18. The point of sale terminal as recited in claim 11, wherein the software installed on the point of sale terminal further performs filtering of one or more transactions in real time, wherein the filtering being performed by:
collecting data associated with the one or more transactions in real time; and
analyzing the collected data associated with the one or more transactions in real time, wherein the analyzing being done by slicing and dicing the collected data to extract information about each of the one or more transactions.

19. The point of sale terminal as recited in claim 11, wherein the payment confirmation information being received on a portable communication device associated with the at least one user of the one or more users, wherein the payment confirmation information being received by the at least one user for a pre-defined range of time and wherein the pre-defined range of time being set by the merchant in real time.

20. The point of sale terminal as recited in claim 11, wherein the plurality of digital payment modes comprises payment through credit card, payment through debit card, payment through scanning the quick response code, payment through the biometric verification and entering the unique identification number and payment through loyalty points.
